(19) United States
(12) Patent Application Publication
(10) Pub. No.: US 2016/0312768 A1
(43) Pub. Date: Oct. 27, 2016

(54) Wind Power Generating Apparatus

(71) Applicant: Kabushiki Kaisha JMP, Hamamatsu-shi (JP)

(72) Inventor: Michiharu TAKAKURA, Hamamatsu-shi (JP)

(21) Appl. No.: 14/694,477

(22) Filed: Apr. 23, 2015

(51) Int. Cl. F03D 9/00; F16C 32/04; F03D 3/00

(52) U.S. Cl. CPC F03D 9/002; F03D 3/005; F16C 32/0427

(57) ABSTRACT

A wind power generating apparatus has a small diameter blade and a large diameter blade to receive wind and rotate a shaft. A generation unit includes a rotor and a stator. The rotor rotates together with the shaft. The stator is fixed in a state facing the rotor. The generation unit generates electricity by rotating the rotor relative to the stator based on the rotation of the small diameter blade and the large diameter blade. A magnetic force supporting unit raises the shaft by a magnetic force and supports the shaft and the blade to freely rotate.

### FIELD

The present disclosure relates to a wind power generating apparatus that can generate electricity by converting wind power into electric power.

### BACKGROUND

In recent years, generating apparatus that uses natural energy has received attention. For example, wind power generating apparatus that can generate electricity by converting wind power into electric power has been suggested in various manners. As disclosed in Japanese Unexamined Patent Application Publication No. 2012-050181, wind power generating apparatus includes a blade that can receive wind and rotate around a shaft member. A generator includes a rotor and a stator. The apparatus is configured to generate electricity by the generator when the shaft member rotates as the blade, receiving the wind, rotates.

However, there is a problem in the above-described wind power generating apparatus in the related art as follows.

In wind power generating apparatus, it is necessary to increase the size of the blade in order to efficiently convert the wind power into the electric power. However, when the size of the blade is large, resistance when the blade rotates increases. This hinders efficient electricity generation, and noise during the rotation increases. Accordingly, there is a problem that installation locations are limited.

### SUMMARY

Accordingly, the present disclosure provides a wind power generating apparatus that performs efficient electricity generation and significantly reduces noise generated when the blade rotates.

According to a first aspect of the disclosure, a wind power generating apparatus generates electricity by converting wind power into electric power. The wind power generating apparatus includes blades, a generation unit and a magnetic force supporting unit. The blades receive wind and rotate around a shaft member. The generation unit includes a rotor and a stator. The rotor rotates together with the shaft member. The stator is fixed in a state facing the rotor. The generation unit generates electricity by rotating the rotor relative to the stator based on the rotation of the blade. The magnetic force supporting unit raises the shaft member by a magnetic force. This supports the shaft member and the blade to enable free rotation.

In the wind power generating apparatus according to a second aspect of the disclosure, the magnetic force supporting unit includes a movable side magnet. The side magnet is formed at a predetermined part of the shaft member. A fixed side magnet is fixed to face the movable side magnet. This raises the shaft member by a repulsive force between the movable side magnet and the fixed side magnet.

In the wind power generating apparatus according to a third aspect of the disclosure, the blades include a small diameter blade that receives wind and rotates around the shaft member. A large diameter blade is set to have a larger diameter than that of the small diameter blade. The large diameter blade includes the small diameter blade on its inner side. The large diameter blade is linked to the shaft member and rotates together with the small diameter blade.

In the wind power generating apparatus according to a fourth aspect of the disclosure, the small diameter blade is made of a Savonius type blade. The large diameter blade is made of a Darrieus type blade.

In the wind power generating apparatus according to a fifth aspect of the disclosure, a plurality of units including the small diameter blade, the large diameter blade, and the generation unit are linked to each other. The small diameter blade and the large diameter blade in each unit are rotatable around the shaft member. Thus, they are independently rotatable in every unit.

According to the first aspect of the disclosure, the magnetic force supporting unit raises the shaft member by the magnetic force. Also, it supports the shaft member and the blade to freely rotate. Thus, it is possible to efficiently generate electricity, and to significantly reduce noise generated when the blade rotates.

According to the second aspect of the disclosure, the magnetic force supporting unit includes the movable side magnet. The movable side magnet is formed at the predetermined part of the shaft member. The fixed side magnet is fixed to face the movable side magnet. This raises the shaft member by a repulsive force between the movable side magnet and the fixed side magnet. Thus, it is possible to raise and support the shaft member by a simpler configuration.

According to the third aspect of the disclosure, the blades include the small diameter blade and the large diameter blade. The small diameter blade receives wind and rotates around the shaft member. The large diameter blade is set to have a larger diameter than that of the small diameter blade. The large diameter blade includes the small diameter blade on its inner side. The large diameter blade is linked to the shaft member and rotates together with the small diameter blade. Thus, it is possible to generate electricity from a lower wind speed by the rotation of the small diameter blade. Also, it is possible to obtain a relatively large generation amount of electricity by the rotation of the large diameter blade. Further, it is possible to reduce the size of the entire apparatus.

According to the fourth aspect of the disclosure, the small diameter blade is made of the Savonius type blade. The large diameter blade is made of the Darrieus type blade. Thus, it is possible to start the rotation of the small diameter blade from a lower wind speed. Also, it is possible to reliably obtain a large generation amount of electricity by the large diameter blade.

According to the fifth aspect of the disclosure, the plurality of units including the small diameter blade, the large diameter blade, and the generation unit are linked to each other. The small diameter blade and the large diameter blade in each unit are independently rotatable around the shaft member in every unit. Thus, it is possible to link an arbitrary number of units to each other in accordance with external environment conditions or a necessary generation amount of electricity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an entire perspective view of a wind power generating apparatus according to the disclosure.

FIG. 2 is a front elevation view of the wind power generating apparatus.

FIG. 3 is a schematic longitudinal cross-sectional view of an internal structure of the wind power generating apparatus.

FIG. 4 is a schematic longitudinal cross-sectional view of an internal structure of a generation unit of the wind power generating apparatus.

FIG. 5 is a schematic plan view of a rotor and a stator of the generation unit in the wind power generating apparatus.

FIG. 6 is a schematic longitudinal cross-sectional view of an internal structure of a magnetic force supporting unit in the wind power generating apparatus.

FIGS. 7A and 7B are a schematic plan view and a schematic front view of a movable side magnet and a fixed side magnet of the magnetic force supporting unit in the wind power generating apparatus.

FIG. 8 is a perspective view of a wind power generating apparatus accommodated in a frame according to another embodiment of the disclosure.

FIG. 9 is a schematic perspective view of a plurality of wind power generating apparatuses linked to each other according to another embodiment.

### DETAILED DESCRIPTION

Hereinafter, an embodiment of the disclosure will be described with reference to the drawings.

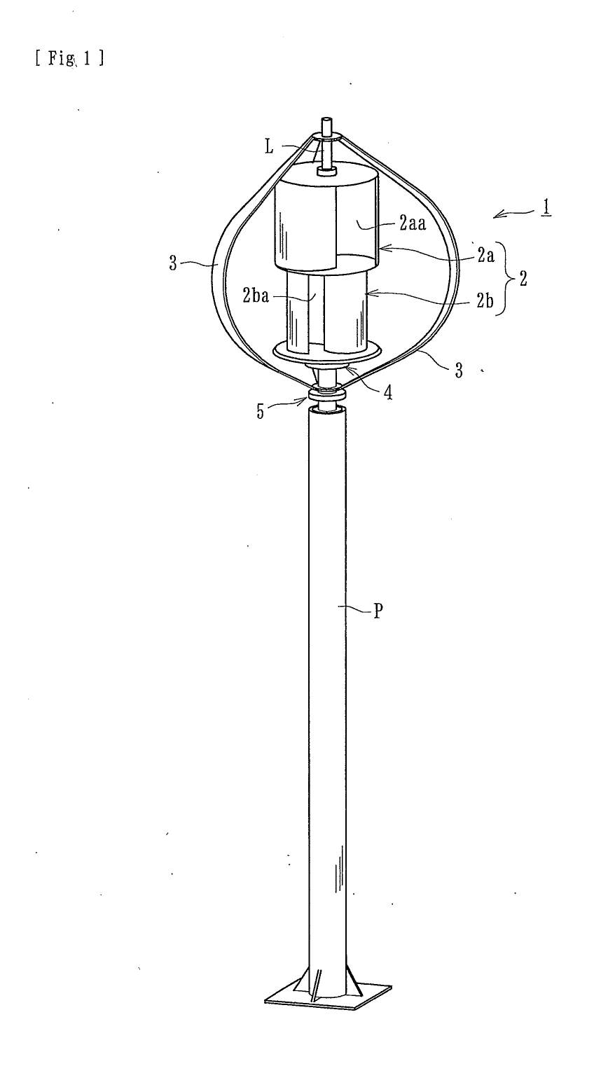

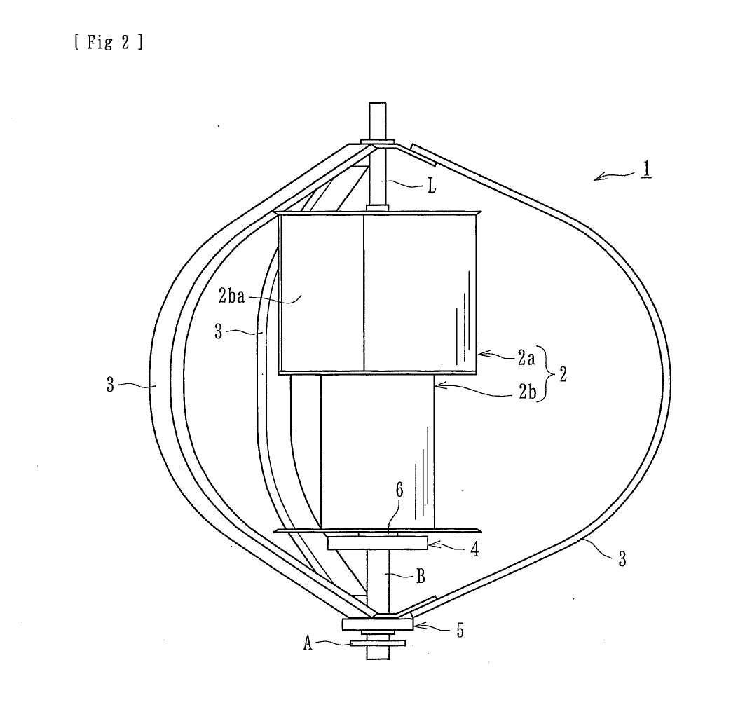

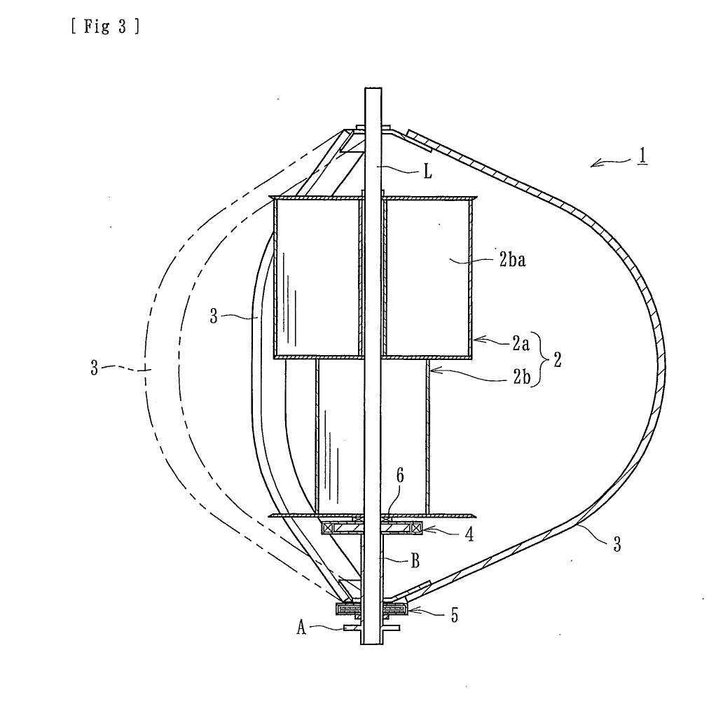

A wind power generating apparatus according to the embodiment can generate electricity by converting wind power into electric power. In FIGS. 1 to 3, the wind power generating apparatus is mainly configured of a small diameter blade 2, a large diameter blade 3, a generation unit 4, a magnetic force supporting unit 5, and a shaft member L. The shaft member L is a rotating shaft of the small diameter blade 2 and the large diameter blade 3. The shaft member L is attached to an upper end of a pole-shaped member P having a predetermined length.

The small diameter blade 2 can receive wind and rotate around the shaft member L. The small diameter blade 2 has a blade configuration referred to as a Savonius type. A so-called windmill type that is included in a vertical type windmill and a drag type windmill. In other words, the small diameter blade 2 has receiving portions (2aa and 2ba) that receive the wind. The small diameter blade 2 is made from a cylindrical member that attaches to the shaft member L. The shaft member L rotates in the same direction when the small diameter blade 2 receives the wind and is rotated by the receiving portions (2aa and 2ba). In the small diameter blade 2 (each of a first small diameter blade 2a and a second small diameter blade 2b), the receiving portions (2aa and 2ba) that, respectively, receive the wind that blows in different directions, can receive the wind from any right side and left side and rotate in the direction.

In addition, in the configuration of the embodiment, the first small diameter blade 2a and the second small diameter blade 2b are provided with different diameters from each other. However, in the embodiment, the first small diameter blade 2a has a larger diameter than that of the second small diameter blade 2b. The first small diameter blade 2a may have a smaller diameter than that of the second small diameter blade 2b. Furthermore, in the embodiment, two small diameter blades 2, that have different diameters from each other, are attached to each other in series. However, only a single small diameter blade may be attached, or three or more small diameter blades with different diameters from each other may be attached in series.

The large diameter blade 3 is configured as a blade referred to as a Darrieus type blade. This is one type of windmill that is included in a so-called vertical type and lift type windmill. The large diameter blade 3 is set to have a larger diameter than that of the small diameter blade 2, the first small diameter blade 2a and the second small diameter blade 2b. The large diameter blade 3 includes the small diameter blade 2 on its inner side. The large diameter blade 3 is linked to the shaft member L. The large diameter blade 3 can rotate together with the small diameter blade 2. More particularly, the large diameter blade 3 according to the embodiment is made of a plurality (three in the embodiment) of blade members that are installed to extend in a shape of an arc. Each end portion of the blade members is linked to the shaft member L. The large diameter blade 3 is installed so that the small diameter blade 2 is disposed on its inner side. In addition, similarly to the small diameter blade 2, the large diameter blade 3, according to the embodiment, can receive wind from any of a right direction and a left direction and rotate in that direction.

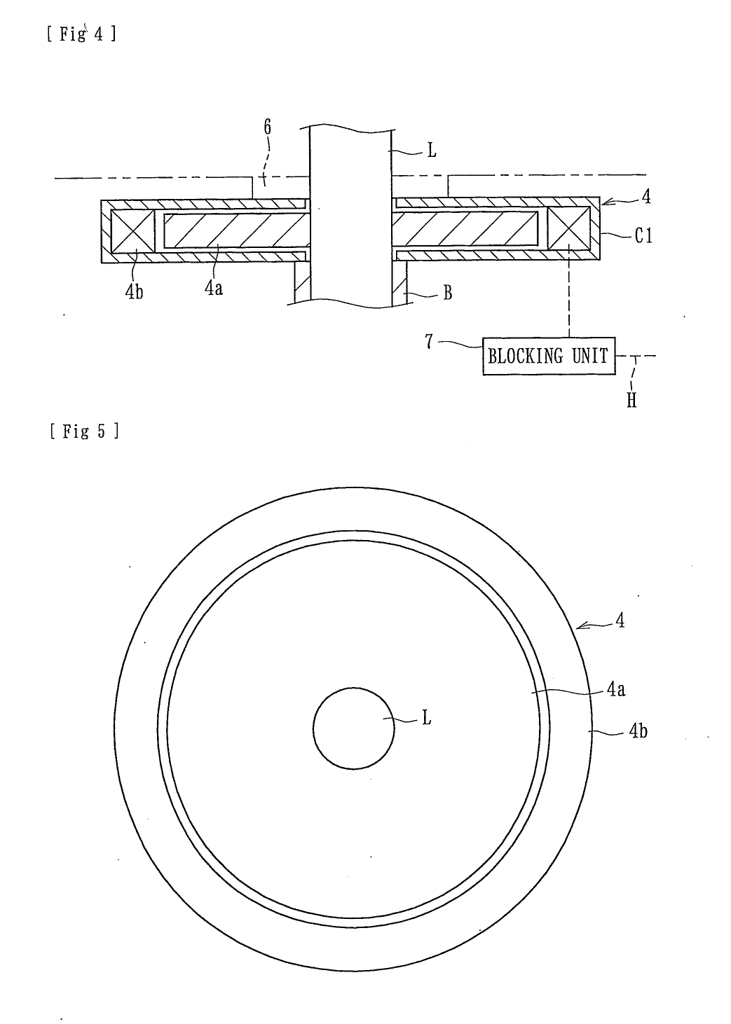

The generation unit 4 is installed below the first small diameter blade 2a and the second small diameter blade 2b. It is positioned parallel to an extending direction of the shaft member L. The generation unit 4 includes a rotor 4a and stator 4b. The rotor 4a rotates together with the shaft member L. The stator 4b is fixed in a state facing the rotor 4a as illustrated in FIGS. 4 and 5. The generation unit 4 generates electricity by rotating the rotor 4a relative to the stator 4b based on the rotation of the small diameter blade 2 and the large diameter blade 3.

In other words, the generation unit 4 according to the embodiment uses a case C1 as a housing. The rotor 4a is fixed to be inserted through a center portion of the shaft member L. The stator 4b surrounds an outer circumference in an annular shape while facing an outer circumferential edge surface of the rotor 4a. The rotor 4a and stator 4b are accommodated in the case C1. When the shaft member L rotates together with the rotor 4a, the rotor 4a can rotate relatively with respect to the stator 4b, which is fixed to the case C1.

In the embodiment, the rotor 4a of the generation unit 4 is made of a permanent magnetic that is fixed to the shaft member L. A coil, that constitutes the stator 4b, is installed along an outer circumference of the permanent magnet. In addition, the rotor 4a, which is made of the permanent magnet, is magnetized. Thus, a north pole and a south pole are alternately formed on the outer circumferential edge surface of the rotor 4a. The rotor 4a can generate a current to the coil, that constitutes the stator 4b, by rotating relative with respect to the stator 4b.

In particular, the generation unit 4 according to the embodiment is made of a so-called three-phase AC generator. The stator 4b includes three groups of coils. The rotor 4a is made of a magnet that rotates relative with respect to the stator 4b. According to this, three waves of current that have different phases are generated. The electricity can be sent to the outside. Furthermore, in this embodiment, in a condition where the small diameter blade 2 and the large diameter blade 3 receive wind and the shaft member L achieves a predetermined rotating speed, a blocking unit 7 is provided (refer to FIG. 4). The blocking unit 7 blocks the electricity from being sent to the outside. The blocking unit 7 is an overspeed prevention control type. The blocking unit 7 is connected to the middle of wiring H that extends to the outside from the stator 4b.

In this embodiment, together with the small diameter blade 2, the first small diameter blade 2a and the second small diameter blade 2b, the generation unit 4 is attached to be included on the inner side of the large diameter blade 3. In other words, the generation unit 4 is attached at a position where its periphery is surrounded by the large diameter blade 3, formed in a shape of an arc. Thus, it is possible to further reduce the entire size of the wind power generating apparatus 1. The generation unit 4 is positioned on the inner side of the large diameter blade 3. Thus, when foreign substances come flying with the wind, it is possible to prevent the foreign substances from striking and damaging the generation unit 4.

In addition, in this embodiment, a cover member B is assembled to extend in a substantially concentric shape with the shaft member L. The case C1 of the generation unit 4 is attached to an upper end portion of the cover member B. In addition, on a lower end portion side of the wind power generating apparatus 1, a flange A is formed. The flange A is fixed to an upper end surface of the pole-shaped member R The entire wind power generating apparatus 1 is fixed.

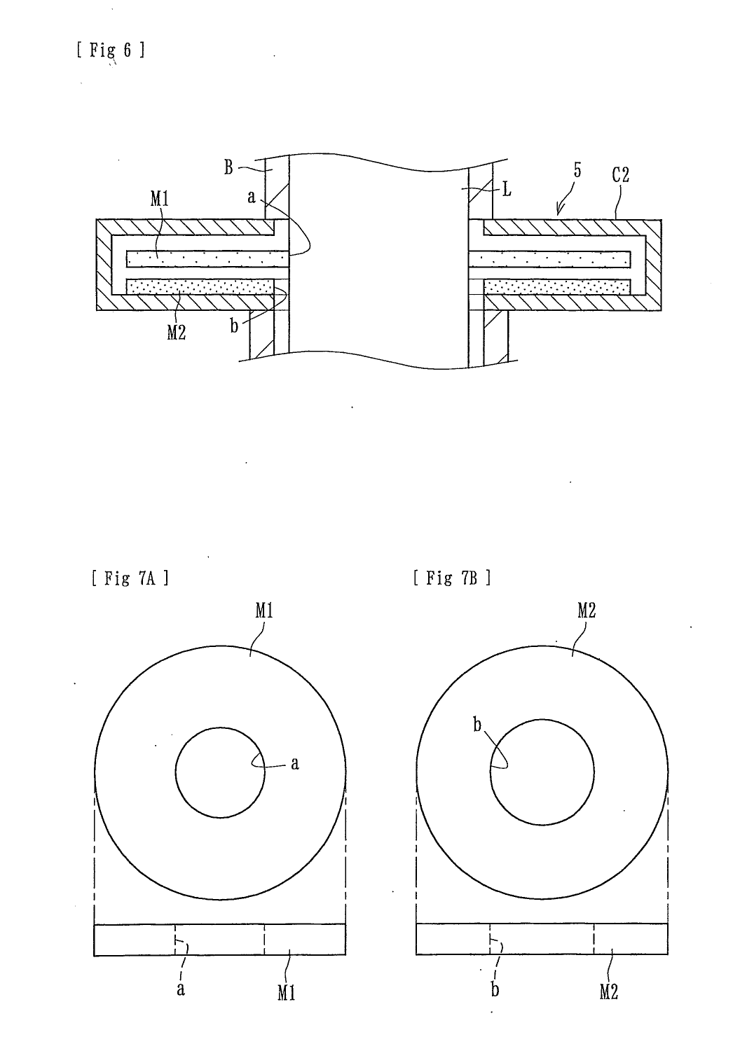

Here, the shaft member L according to this embodiment is supported by the magnetic force supporting unit 5. The magnetic force supporting unit 5 can raise the shaft member L by a magnetic force. Thus, the magnetic force supporting unit 5 supports the shaft member L, the small diameter blade 2, the first small diameter blade 2a and the second small diameter blade 2b, and the large diameter blade 3 for free rotation. As illustrated in FIGS. 6 to 7B, the magnetic force supporting unit 5 includes a case C2 as a housing. The magnetic force supporting unit 5 includes a movable side magnet M1 and a fixed side magnetic M2. The movable side magnet M1 is formed at a predetermined part of the shaft member L and is rotatable together with the shaft member L. The fixed side magnet M2 is fixed to the case C2 while facing one surface, lower surface in the embodiment, of the movable side magnet M1, in the case C2.

More specifically, the movable side magnet M1 and the fixed side magnet M2 are respectively made of permanent magnets in the shape of a disk, as illustrated in FIGS. 6 to 7B. An inner-diameter dimension of a center hole (a) in the movable side magnet M1 is set to be substantially the same as an outer-diameter dimension of the shaft member L. An inner-diameter dimension of a center hole (b) in the fixed side magnet M2 is set to be slightly greater than the outer-diameter dimension of the shaft member L. In addition, the shaft member L is fixed to the movable side magnet M1 by inserting the shaft member L through the center hole (a) of the movable side magnet M1. The fixed side magnet M2 is fixed to the case C2. During assembly, the shaft member L is inserted through the center hole (b). Thus, the shaft member L freely rotates in a state where a clearance is generated between the shaft member L and an inner circumferential surface of the center hole (b).

The movable side magnet M1 and the fixed side magnet M2 are positioned with respect to one another such that their mutually facing surfaces are the same pole, the south pole or the north pole. This supports the shaft member L by raising the shaft member L by a repulsive force between the movable side magnet M1 and the fixed side magnet M2. In addition to the magnetic force supporting unit 5, the shaft member L is supported to freely rotate by a general-purpose bearing unit 6. The bearing unit 6 is of a roller bearing or a needle bearing type. Accordingly, the shaft member L is supported to be raised in a axial direction by the magnetic force of the magnetic force supporting unit 5. Thus, when the small diameter blade 2, the first small diameter blade 2a and the second small diameter blade 2b, and the large diameter blade 3 receive wind, the shaft member L can rotate while being retained in the raised state.

Furthermore, in the embodiment described above, the small diameter blade 2, the first small diameter blade 2a and the second small diameter blade 2b is made of a Savonius type blade. The large diameter blade 3 is made of a Darrieus type blade. The small diameter blade 2, the first small diameter blade 2a and the second small diameter blade 2b can start rotating at a lower wind speed than that of the large diameter blade 3. Accordingly, since the small diameter blade 2, the first small diameter blade 2a and the second small diameter blade 2b, starts rotating from the time when the wind is gentle (weak), and the large diameter blade 3 can be rotated together with the shaft member L, it is possible to cut in even when the wind speed is low.

In addition, the small diameter blade 2 may be another type of blade, such as a drag type blade, a paddle type blade, a cross-flow type blade, or an S type rotor type blade, other than the Savonius type blade. The large diameter blade 3 may be another type of blade (a lift type blade is preferable), such as a gyro-mill type blade or a straight wing type blade, other than the Darrieus type blade.

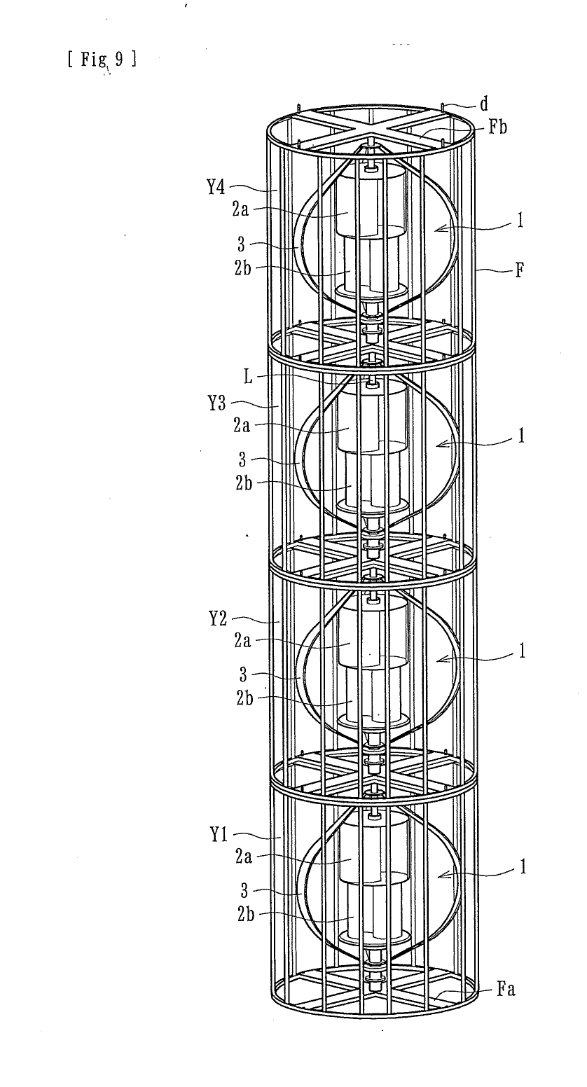

In the embodiment illustrated in FIG. 9, a plurality (four in the embodiment) of units (Y1 to Y4) are provided. The small diameter blade 2, the first small diameter blade 2a and the second small diameter blade 2b, the large diameter blade 3, and the generation unit 4 are linked to each other. The small diameter blade 2, the first small diameter blade 2a and the second small diameter blade 2b, and the large diameter blade 3 of each unit (Y1 to Y4) are rotatable around the shaft member L that can independently rotate in every unit (Y1 to Y4).

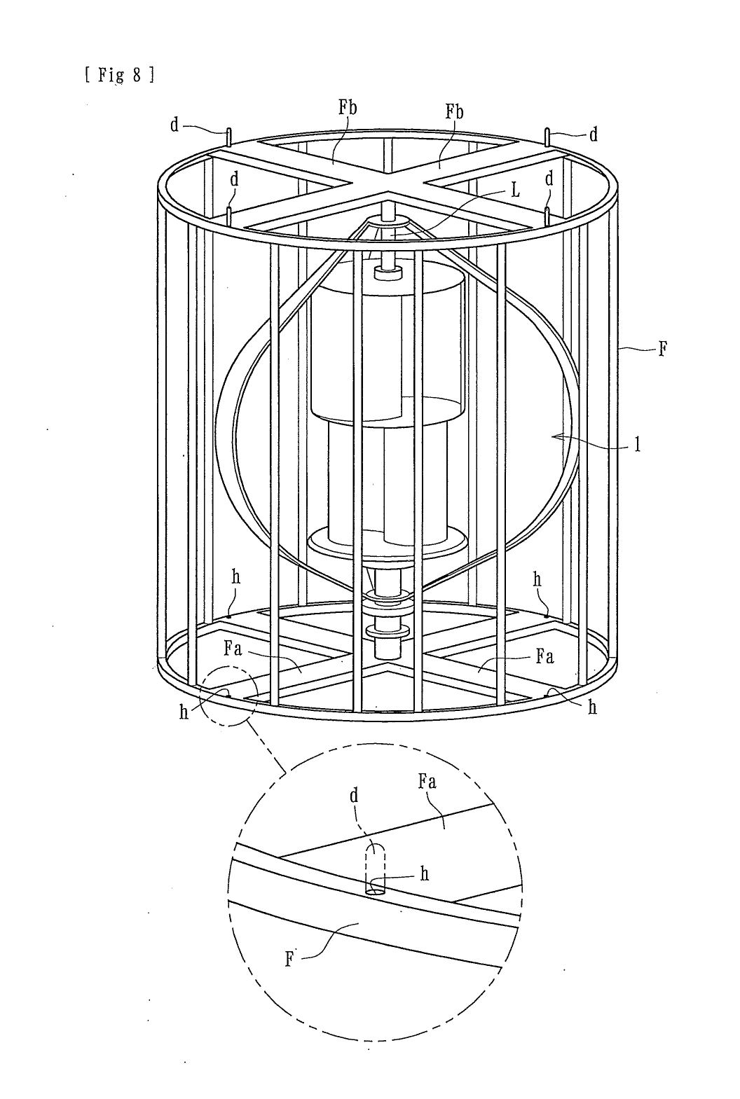

In other words, in each unit, as illustrated in FIG. 8, the small diameter blade 2, the first small diameter blade 2a and the second small diameter blade 2b, the large diameter blade 3, and the generation unit 4 are accommodated by a metal frame F. Each supporting frame Fa and Fb is fixed in a cross shape in a lower portion and in an upper portion of the frame F. The shaft member L is supported between the supporting frame Fa and the supporting frame Fb.

In addition, four positioning holes h are formed at predetermined positions in the lower portion of the frame F. Four positioning bolts (d) protrude upward at predetermined positions in the upper portion of the frame F. In addition, by stacking the plurality of frames F in the vertical direction, inserting and positioning each positioning bolt (d) in the lower frame F into the positioning hole h in the upper frame F, and linking the units (Y1 to Y4) in the vertical direction, the plurality of wind power generating apparatuses 1 are linked to each other in series (in the vertical direction).

In particular, in the embodiment, when the wind blows from a certain direction, the blades (the small diameter blade 2 ((the first small diameter blade 2a and the second small diameter blade 2b)) and the large diameter blade 3) of the adjacent units (Y1 to Y4) can rotate in directions reverse to each other. For example, when the wind blows in a certain direction, the blades (the small diameter blade 2 ((the first small diameter blade 2a and the second small diameter blade 2b)) and the large diameter blade 3: the same hereinafter) of the uppermost unit Y4 rotate clockwise (in plan view). The blades of the unit Y3, positioned at the second position from the top, rotate counter-clockwise (in plan view). The blades of the unit Y2, positioned at the third position from the top, rotate clockwise. The blades of the lowermost unit Y1 rotate counter-clockwise. In this manner, the rotating directions of the blades are different from each other, alternately right and left. Accordingly, all of the linked units can avoid resonating and violently vibrating right and left, and the wind power generating apparatus can be stably installed.

According to the above-described embodiment, the magnetic force supporting unit 5 raises the shaft member L by the magnetic force. The magnetic force supporting unit 5 supports the shaft member L and the blades (the blades ((the first small diameter blade 2a, the second small diameter blade 2b, and the large diameter blade 3)) in the embodiment) for free rotation. Thus, it is possible to efficiently generate electricity and to significantly reduce noise generated when the blades rotate. In other words, by raising the shaft member L by the magnetic force, it is possible to reduce sliding resistance when the blades rotate and to improve generating efficiency and reduce noise.

In addition, the magnetic force supporting unit 5 according to the embodiment includes the movable side magnet M1 and the fixed side magnet M2. The movable side magnet M1 is formed at a predetermined position on the shaft member L. The fixed side magnet M2 is fixed to the case C2 and faces the movable side magnet M1. The magnets M1, M2 raise the shaft member L by the repulsive force between the movable side magnet M1 and the fixed side magnet M2. Thus, it is possible to support the shaft member L while raising the shaft member L with a simple configuration. In particular, in the embodiment, the shaft member L and the blades are supported against gravity by the magnetic force of the magnetic force supporting unit 5. Additionally, they are supported to freely rotate by the bearing unit 6. Thus, it is possible to maintain smooth rotation while further reducing resistance when the blades rotate.

Furthermore, the blade according to the embodiment includes the small diameter blade 2 and the large diameter blade 3. The blade receives wind and rotates around the shaft member. The large diameter blade 3 is set to have a diameter larger than that of the small diameter blade 2. The small diameter blade 2 is on the inner side of the large diameter blade 3 and is linked to the shaft member L. The large diameter blade 3 can rotate together with the small diameter blade 2. Thus, it is possible to generate electricity from lower wind speed by the rotation of the small diameter blade 2 and to obtain a relatively greater generation amount of electricity by the rotation of the large diameter blade 3. Additionally, it is possible to achieve a small size of the entire apparatus.

In addition, according to the embodiment, the small diameter blade 2 is made of a Savonius type blade. The large diameter blade 3 is made of a Darrieus type blade. Thus, it is possible to start the rotation of the small diameter blade 2 from a lower wind speed, and to reliably obtain a large generation amount of electricity by the large diameter blade 3.

In addition, the plurality of units (Y1 to Y4) is provided with the small diameter blade 2, the large diameter blade 3, and the generation unit 4 linked to each other. The small diameter blade 2 and the large diameter blade 3 of each unit (Y1 to Y4) are rotatable around the shaft member that can independently rotate in every unit (Y1 to Y4). Thus, it is possible to link an arbitrary number of units in accordance with the external environment or the required generation amount of electricity.

In particular, according to the embodiment, the plurality of units (Y1 to Y4) provided with the small diameter blade 2, the large diameter blade 3, and the generation unit 4 are linked to each other. The shaft member L extends across the plurality of linked units (Y1 to Y4). The blades of each unit can be raised by the magnetic force supporting unit 5 and rotate around the shaft member L. Thus, it is possible to link an arbitrary number of units in accordance with the external environment and the required generation amount of electricity to efficiently generate electricity, and to significantly reduce noise generated when the blades rotate.

In addition, according to the embodiment, the small diameter blade 2, the first small diameter blade 2a and the second small diameter blade 2b receives wind and rotates around the shaft member L. The large diameter blade 3 has a diameter greater than that of the small diameter blade 2, the first small diameter blade 2a and the second small diameter blade 2b. The small diameter blade 2 can be positioned on the inner side of the large diameter blade. The large diameter blade 3 is linked to the shaft member L. The large diameter blade 3 can rotate together with the small diameter blade 2. The small diameter blade 2 can start rotating at a lower wind speed than that of the large diameter blade 3. Thus, it is possible to generate electricity from lower wind speed by the rotation of the small diameter blade 2, and to obtain a relatively larger generation amount of electricity by the rotation of the large diameter blade 3. Additionally, it is possible to achieve a small size of the entire apparatus.

In addition, the rotor 4a of the generation unit 4 includes a permanent magnet fixed to the shaft member L. The coil, that constitutes the stator 4b, is installed along the outer circumference of the permanent magnet. Thus, it is possible to further improve electricity generating efficiency. Furthermore, the blocking unit 7 blocks the electricity from being sent to the outside in a condition where the small diameter blade 2 and the large diameter blade 3 receive wind and the shaft member L achieves a predetermined rotating speed. Thus, it is possible to prevent an excessive electrical load from being generated in the external electrical system.

Above, an embodiment is described, however, the disclosure is not limited. For example, instead of being attached to the upper end of the pole-shaped member P, the wind power generating apparatus 1 may be installed at an arbitrary location, on a roof or the like where winds blow. In addition, the blade according to the embodiment includes the small diameter blade 2 and the large diameter blade 3, however, the blade may be made of one type of blade. Furthermore, an accumulating unit that accumulates the electricity that is generated by the generation unit 4 may be provided. In addition, in the generation unit 4 according to the embodiment, the rotor 4a is made of the permanent magnet, however, may be made of an electro-magnet.

The wind power generating apparatus 1, including a magnetic force supporting unit that raises the shaft member by a magnetic force and supports the shaft member and the blade to freely rotate, can be applied to apparatii with different appearances or with other functions.

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A wind power generating apparatus that generates electricity by converting wind power into electric power, the apparatus comprising:
blades that receive wind and rotate around a shaft;
a generation unit including a rotor and a stator, the rotor rotates together with the shaft, the stator is fixed in a state facing the rotor, the generation unit generates electricity by rotating the rotor relative to the stator based on the rotation of the blade; and
a magnetic force supporting unit raises the shaft by a magnetic force and supports the shaft and the blade to freely rotate.

2. The wind power generating apparatus of claim 1, wherein the magnetic force supporting unit includes a movable side magnet and a fixed side magnet, the movable side magnet is a predetermined part of the shaft, the fixed side magnet is fixed to face the movable side magnet, the movable side and fixed side magnets raise the shaft by a repulsive force between the movable side magnet and the fixed side magnet.

3. The wind power generating apparatus of claim 1, wherein the blades include a small diameter blade that receives wind and rotates around the shaft, and a large diameter blade with a diameter larger than that of the small diameter blade, the small diameter blade is positioned on an inner side of the large diameter blade, the large diameter blade is linked to the shaft, and rotates together with the small diameter blade.

4. The wind power generating apparatus of claim 3, wherein the small diameter blade is a Savonius type blade, and the large diameter blade is a Darrieus type blade.

5. The wind power generating apparatus of claim 1, wherein a plurality of units including the small diameter blade, the large diameter blade, and the generation unit are linked to each other, and the small diameter blade and the large diameter blade in each unit are rotatable around the shaft that is independently rotatable in every unit.

6. A wind power generating apparatus that generates electricity by converting wind power into electric power, the apparatus comprising:
blades that receive wind and rotate around a shaft;
a generation unit including a rotor and a stator, the rotor rotates together with the shaft, the stator is fixed in a state facing the rotor, the generation unit generates electricity by rotating the rotor relative to the stator based on the rotation of the blade; and
a magnetic force supporting unit raises the shaft by a magnetic force and supports the shaft and the blade and the rotor of the generation unit to freely rotate.
